(19) United States
(12) Patent Application Publication
(10) Pub. No.: US 2026/0199073 A1
(43) Pub. Date: Jul. 16, 2026

(54) Sensing Platforms for Detecting Pathologies in Livestock

(71) Applicants: John P. Hanks, Austin, TX (US); Amir Tofighi Zavareh, College Station, TX (US); Michael J. McShane, College Station, TX (US); Waqas Saleem, College Station, TX (US)

(72) Inventors: John P. Hanks, Austin, TX (US); Amir Tofighi Zavareh, College Station, TX (US); Michael J. McShane, College Station, TX (US); Waqas Saleem, College Station, TX (US)

(73) Assignee: The Texas A&M University System, College Station, TX (US)

(21) Appl. No.: 19/450,026

(22) Filed: Jan. 15, 2026

Related U.S. Application Data
(60) Provisional application No. 63/745,737, filed on Jan. 15, 2025.

(51) Int. Cl. A61D 7/00

(52) U.S. Cl. CPC A61D 7/00

(57) ABSTRACT

Optical biosensors, an injectable hydrogel sensing platform containing the optical biosensors and a stand-off reading instrument that are components of a system to measure a iomarker associated with a pathology in livestock. The optical biosensor is a fluorinated metalloporphyrin dye complex encapsulated within a plurality of functionalized particles coated with layers of a polyelectrolyte nanofilm. Also provided is a method for detecting a pathology in livestock using the system.

### CROSS-REFERENCE TO RELATED APPLICATIONS

This non-provisional patent application claims benefit of priority under 35 U.S.C. § 119(e) of provisional application U.S. Ser. No. 63/745,737, filed Jan. 15, 2025, the entirety of which is hereby incorporated by reference.

### BACKGROUND OF THE INVENTION

### Field of the Invention

The present invention relates generally to the fields of livestock pathologies and biosensing. Specifically, the present invention relates to an optical biosensor and a stand-off reading instrument configured to optically excite and read signals emitted by the optical biosensor to detect pathologies in livestock.

### Description of the Related Art

Precision livestock farming today includes cow-side point-of-care (POC) devices that utilize biosensor technologies to monitor metabolites or other biomarkers in biological fluids (e.g., blood, urine, saliva) for diagnostic and early detection of infectious and metabolic diseases in livestock. Multiple point-of-care-based biosensors have been developed for the early detection of metabolic diseases in dairy cows, which commonly occur during the transition from late pregnancy to early lactation. Examples include the detection of blood calcium concentrations and urine pH for the detection of clinical and subclinical cases of hypocalcemia (milk fever), blood lactate concentrations for the detection of displaced abomasal disorders, and beta-hydroxybutyrate (BHB) concentrations in blood or milk for the detection of clinical and subclinical cases of ketosis.

These point-of-care biosensors enable more rapid diagnostic results, to facilitate more effective treatment, and mitigate the detrimental economic impacts of metabolic diseases. Industry adoption of point-of-care-based technologies, however, has been low due to their high costs and the need for sample preparation and instrument calibration. Furthermore, current point-of-care biosensors only provide snapshots in time of specific biomarkers relative to predetermined thresholds used to define subclinical or clinical cases. As substantial between-herds (e.g. diet, parity) and inter-animal variation can exist for specific biomarkers, single-point-in-time measurements of biomarkers have limited accuracy in differentiating healthy vs unhealthy cohorts. In agriculture, biosensing technologies have the potential to improve livestock health management through early disease detection. However, large scale adoption has been hindered, primarily because of challenges such as tissue attenuation of signals, sunlight interference, and animal movement.

One pressing health concern in livestock is Bovine Respiratory Disease (BRD), a costly respiratory condition in cattle caused by pathogens such as viruses (e.g. bovine herpesvirus) and bacteria (e.g. Mannheimia haemolytica) (5). Bovine Respiratory Disease commonly affects calves, particularly during stressful events contributing to high morbidity and mortality rates. Bovine Respiratory Disease is a major challenge in livestock management causing morbidity and mortality among calves (1).

Common diagnostics are based on enzyme-linked immunosorbent assay (ELISA), immunohistochemistry (IHC), and polymerase chain reaction (PCR), are accurate but costly and labor intensive, making them unsuitable for real time on-farm disease detection. Therefore, current field diagnostics rely on manual observation, infrared thermometers, and radio-frequency identification (RFID) tags, which are susceptible to human error. Conventional implantable biosensors require trocar-based surgical implantation, causing tissue trauma, immune response, and limiting scalability. The need for surgical expertise and post-implantation monitoring further reduces their feasibility for large-scale livestock management.

Studies have demonstrated the efficacy of phosphorescent dyes like Pt-penafluorobenzopophyrin (Pt-TFBP) in improving signal detection under ambient light interference (2-4). These dyes utilize the Fraunhofer effect, emitting light at wavelengths with minimal solar interference. Building on this basis, biocompatible hydrogel embedded with oxygen sensitive microparticles have been developed (5, 6), demonstrating stability and extended in vivo applicability for up three months. While these advancements mark significant progress, they remain confined to laboratory settings. Current solutions approved for human use employ phosphorescent metal-porphyrin complexes for tissue oxygenation monitoring (7) and require trocar based surgical implantation. Moreover, a major obstacle is mitigating the foreign body response, a natural immune reaction that can compromise the biosensor performance over time (8).

Thus, there is an unmet need in the art to develop biosensing technologies capable of continuously monitoring deviations in biomarker responses at the animal level to predict disease outcomes more accurately. Particularly, the art is deficient in an injectable hydrogel-based biosensor system for early detection of pathologies in livestock. The present invention fulfils this longstanding need in the art.

### SUMMARY OF THE INVENTION

The present invention is directed to an optical biosensor. The biosensor has a fluorinated metalloporphyrin dye complex electrostatically encapsulated by a plurality of functionalized microparticles or nanoparticles coated with layers of a polyelectrolyte nanofilm. The present invention is directed to a related optical biosensor further comprising a functionalizing enzyme encapsulated with the fluorinated metalloporphyrin dye complex.

The present invention is further directed to an injectable hydrogel sensing platform. The sensing platform comprises the optical biosensor described herein and a shear-thinning hydrogel matrix encapsulating the optical biosensor where the shear-thinning hydrogel matrix is formulated from two polyethylene glycol functionalized polymers crosslinkable upon injection into a tissue.

The present invention is directed further to a system to measure a biomarker associated with a pathology in livestock. The system has the injectable hydrogel sensing platform described herein and a stand-off reading instrument configured to both optically excite the optical biosensor and read phosphorescent light signals emitted therefrom at a distance in the presence of the biomarker. The stand-off reading instrument is in electronic communication with a cloud-based platform. A database is configured for correlation of the emitted phosphorescent light signals with the pathology.

The present invention is directed further still to a method for detecting a pathology in livestock. In this method, the injectable hydrogel sensing platform comprising the system described herein is injected into at least one of the livestock where the two polyethylene glycol polymers crosslink upon injection thereby encapsulating the optical biosensor. The stand-off reading instrument excites the optical biosensor with a Fraunhofer wavelength selected to produce phosphorescent light signals emitted from the optical biosensor in the presence of a biomarker associated with the pathology. The phosphorescent light signals are received in the stand-off reading instrument and are transmitted to a cloud-based platform as data for analysis as correlative with the pathology. The present invention is directed to a related method further comprising storing the data in the cloud-based platform. The present invention is directed to another related method further comprising monitoring the livestock for the presence or an absence of the biomarker as indicative of a presence or an absence of the pathology.

Other and further aspects, features, and advantages of the present invention will be apparent from the following description of the presently preferred embodiments of the invention. These embodiments are given for the purpose of disclosure.

### BRIEF DESCRIPTION OF THE DRAWINGS

So that the matter in which the above-recited features, advantages and objects of the invention, as well as others which will become clear, are attained and can be understood in detail, more particular descriptions of the invention briefly summarized above may be had by reference to certain embodiments thereof which are illustrated in the appended drawings. These drawings form a part of the specification. It is to be noted, however, that the appended drawings illustrate preferred embodiments of the invention and therefore are not to be considered limiting in their scope.

FIGS. 1A-1G show postsurgical oxygen monitoring of the implantable oxygen monitors. FIG. 1A shows the qualitative visualization of the subcutaneous implants after 3 months in vivo, demonstrating the durability of the signal from implanted sensors. FIGS. 1B-1G show interstitial oxygen concentrations in micromoles, calculated by calibrating in vivo lifetime measurements to in vitro oxygen calibration data.

FIG. 2 is a scheme for the fabrication and designing of sensing microparticles and shear-thinning hydrogel materials.

FIG. 3 is a schematic of the ambient light cancellation system.

### DETAILED DESCRIPTION OF THE INVENTION

As used herein, the terms “comprise” and “comprising” are used in the inclusive, open sense, meaning that additional elements may be included.

As used herein, the terms “consist of” and “consisting of” are used in the exclusive, closed sense, meaning that additional elements may not be included.

As used herein, the term “about” refers to a numeric value, including, for example, whole numbers, fractions, and percentages, whether or not explicitly indicated. The term “about” generally refers to a range of numerical values (e.g., ±5-10% of the recited value) that one of ordinary skill in the art would consider equivalent to the recited value (e.g., having the same function or result). In some instances, the term “about” may include numerical values that are rounded to the nearest significant figure.

As used herein, the conditional language, such as, among others, “can”, “might”, “may”, “e.g.”, “for example”, and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

As used herein, the terms “stand-off reading instrument” and “stand-off reader” are used interchangeably.

As used herein, the term “livestock” refers to farm animals, such as, but not limited to, dairy cows, beef cattle, calves, and other feed animals.

As used herein, the term “livestock pathologies” refers to, but is not limited to, mastitis, respiratory disease, for example, bovine respiratory disease, gastrointestinal disease, for example, scours, hypocalcemia, displaced abomasal disorder, or ketosis.

As used herein, the term “biomarker” refers to, but is not limited to, oxygen, temperature, glucose, beta-hydroxybutyrate, lactate, pH, or calcium

In one embodiment of the present invention, there is provided an optical biosensor, comprising a fluorinated metalloporphyrin dye complex; and a plurality of functionalized particles coated with layers of a polyelectrolyte nanofilm electrostatically encapsulating the fluorinated metalloporphyrin dye complex. Further to this embodiment, the optical biosensor comprises a functionalizing enzyme encapsulated with the fluorinated metalloporphyrin dye complex.

In both embodiments, the fluorinated metalloporphyrin dye complex may be a Pt(II) meso-Tetra (4-fluorophenyl)-tetrabenzoporphyrin dye complex or a Pd(II) meso-Tetra (4-fluorophenyl)-tetrabenzoporphyrin dye complex. Also, in both embodiments, the fluorinated metalloporphyrin dye complex may emit phosphorescent light at a solar Fraunhofer line. In addition, the functionalized particles may be functionalized microparticles or functionalized nanoparticles. Particularly, the plurality of functionalized microparticles or functionalized nanoparticles each may comprise sulfate latex coated with polyallylamine hydrochloride.

In another embodiment of the present invention, there is provided an injectable hydrogel sensing platform, comprising the optical biosensor as described supra; and a shear-thinning hydrogel matrix encapsulating the optical biosensor, where the shear-thinning hydrogel matrix is formulated from two polyethylene glycol functionalized polymers crosslinkable upon injection into a tissue. In this embodiment, the two polyethylene glycol functionalized polymers may comprise polyethylene glycol-vinyl sulfone and polyethylene glycol-thiol.

In yet another embodiment of the present invention, there is provided a system to measure a biomarker associated with a pathology in livestock, comprising the injectable hydrogel sensing platform as described supra; a stand-off reading instrument configured to both optically excite the optical biosensor and read phosphorescent light signals emitted therefrom at a distance in the presence of the biomarker; where the stand-off reading instrument is in electronic communication with a cloud-based platform; and a database configured for correlation of the emitted phosphorescent light signals with the pathology.

In this embodiment, the stand-off reading instrument may be configured for a distance of at least 1.0 cm. Also in this embodiment, the optical biosensor has an emission wavelength at a solar Fraunhofer line. In addition, a representative wavelength is about 760 nm.

In yet another embodiment of the present invention, there is provided a method for detecting a pathology in livestock, comprising injecting the injectable hydrogel sensing platform comprising the system as described supra into at least one of the livestock, the two polyethylene glycol polymers crosslinking upon injection thereby encapsulating the optical biosensor; exciting, via the stand-off reading instrument, the optical biosensor with a Fraunhofer wavelength selected to produce phosphorescent light signals emitted from the optical biosensor in the presence of a biomarker associated with the pathology; receiving, in the stand-off reading instrument, the phosphorescent light signals; and transmitting the phosphorescent light signals to a cloud-based platform as data for analysis as correlative with the pathology.

Further to this embodiment, the method comprises storing the data in the cloud-based platform. In another further embodiment, the method comprises monitoring the livestock for the presence or an absence of the biomarker as indicative of a presence or an absence of the pathology. In this further embodiment, data collected during the monitoring step comprises input with previously collected data for a machine learning algorithm configured to analyze the input to generate information predictive of the pathology in the livestock.

In all embodiments, analysis of the data comprises comparing the emitted phosphorescent light signals to a database. Also in all embodiments, the biomarker may be oxygen, temperature, glucose, beta-hydroxybutyrate, lactate, pH, or calcium. In addition, the pathology is scours, bovine respiratory disease, mastitis, hypocalcemia, displaced abomasal disorder, or ketosis. Furthermore, the livestock may be dairy cattle, beef cattle or other feed animals.

Provided herein is a shear-thinning, self-crosslinking hydrogel that enables simple syringe-based injection system effective for livestock health monitoring, minimizing animal stress, increasing the sensor surface area, and integrating seamlessly into farm workflows. The hydrogel includes embedded metal-porphyrin phosphorescent dyes tuned to Fraunhofer absorption lines that, at 760 nm, reduce ambient sunlight interference and hence provide very accurate outdoor agricultural detection of oxygen.

The injectable biosensor is the first of its kind that utilizes a specific fluorinated platinum or palladium benzoporphyrin that emits phosphorescent light at the solar Fraunhofer line. The benzoporphyrin dye may either be directly crosslinked to a primary polymeric matrix or coupled to/encapsulated within polymeric micro/nanoparticles containing the functionalizing enzyme. The enzyme makes it so that the biosensor consumes oxygen in the presence of a bio-analyte of interest and the micro/nanoparticles are designed to modify the transport of oxygen and the analyte of interest to and from the encapsulated benzoporphyrin molecules. Before injection, the biosensor is mixed with a secondary crosslinking polymer with shear-thinning properties that make it easily injectable to the tissue. Once injected, the biosensor is cross-linked in situ avoiding its migration in the body.

The system comprises a stand-off optical reader that wirelessly detects phosphorescence emission decay from up to 3 cm with an accuracy >98% R², reducing the need of invasive procedures or manual handling. The microparticles within the hydrogel are stabilized, maintaining biocompatibility and functionality for at least three weeks, thus meeting the critical early disease detection window for livestock pathologies, such as, but not limited to bovine respiratory disease (BRD). The system integrates durability in outdoor conditions, minimal invasiveness, and scalability, providing a cost-effective and practical solution that addresses the limitation of existing technologies for large-scale livestock management.

Also provided are methods for monitoring livestock for pathologies by injecting the livestock with the components of the shear-thinning, self-crosslinking hydrogel optical sensor. The stand-off reader both optically excites and read signals emitted by the optical biosensor in the presence of a biomarker, for example, oxygen, over time for the presence of the livestock pathology.

Particularly, the system has the following features:
1) Shear-Thinning Injectable Sensor for Streamlined Deployment: The injectable, shear-thinning, self-crosslinking hydrogel is designed for simple, syringe-based injections, seamlessly integrating into existing agricultural workflows, such as, but not limited to, calf blood sampling, and dramatically reducing deployment time to under 20 seconds and costs. This formulation eliminates the need for surgical procedures, minimizing animal stress and making it practical for farm settings.
2) Advanced optical detection: The system measures the decay time of the returning signal, which is proportional to the oxygen concentration. Distance variations (within 3 cm) have minimal impact on the measurement's accuracy. The detector design includes a recessed optical cup that ensures consistent sensor placement relative to the tissue. The cup's fixed 3 cm length maintains a constant sensing distance and acts as a solar shield, blocking ambient sunlight and increasing signal clarity.
3) Signal stability: Preliminary animal studies have demonstrated signal stability for 90 days. Initial instability during the first 1-2 days post injection, due to immune response, has been mitigated by transitioning from trocar-based implantation to syringe-based injection, reducing tissue trauma. In calf ranch application, the system's 21-day functional window perfectly aligns with the early calf management window.
4) Precise optical detection: The hydrogel emits 250 picowatts of power, detectable by a 1 cm² optical reader from up to 3 cm, even under outdoor agricultural conditions.
5) Fraunhofer Line Tuning: The emission wavelength is set at 760 nm, aligning with a Fraunhofer absorption line where solar interference is minimal, providing 98% accurate reading in direct sunlight.
6) Real-time monitoring and data processing: The collected data are wirelessly transmitted to a cloud-based platform, where machine learning algorithms analyze live and historical readings to generate insights that can predict BRD.

The following examples are given for the purpose of illustrating various embodiments of the invention and are not meant to limit the present invention in any fashion.

### Example 1

### Preliminary Design of Oxygen Responsive Biosensors

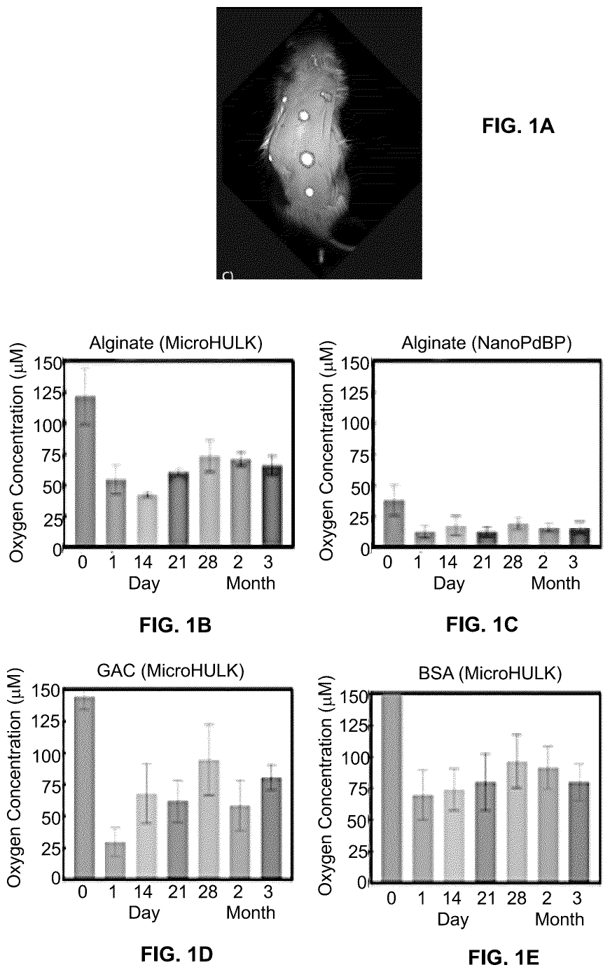

Several examples of optically responsive biosensors for various target analytes (oxygen, glucose, and lactate) (5, 9-11) have been reported. These sensors were fabricated by incorporating oxygen-sensitive metalloporphyrin dyes into alginate microparticles, which were then embedded into various hydrogel materials for the intended applications. In a key example oxygen-sensing hydrogels were fabricated by impregnation of the metalloporphyrin dye into ethyl cellulose nanoparticles, embedding such nanoparticles into alginate microparticles, into different biomaterial hydrogels. These oxygen sensors were later implanted into the subcutaneous tissues of rats (FIG. 1A). The reader heads are gently placed against the unrestrained rat's skin. The excitatory red LED causes the phosphors to emit an infrared light for some microseconds. The oxygen sensors were evaluated for sensor functionality in terms of phosphorescence lifetimes for up to 3 months, followed by tissue histology assessments (FIGS. 1B-1G). These devices performed consistently for more than 3 months in an immune-competent animal model. Sensors reported interstitial oxygen concentrations in the physiological range throughout the experiment with different average oxygen concentrations between different hydrogel types and phosphor stabilization methods. Histopathological analysis confirmed that all designs were highly biocompatible and induced noninflammatory healing responses characterized by chronic phagocytic degradation of the devices.

### Stand-Off Optical Reader Prototype

An initial prototype for the stand-off optical reader was developed to detect phosphorescent emissions from implanted sensors at 13 cm. This prototype integrates state-of-the-art opto-electromechanical systems, including an excitation channel with eight 625 nm LEDs in a ring light configuration to illuminate the implanted sensor. The emitted light is captured by a photomultiplier array and the signal is converted into voltage output by the transimpedance amplifier (TIA) and recorded by the data acquisition system. Equipped with a lithium-ion battery-powered robust power management system, in synchronization, the signal collection is controlled through a microcontroller manufactured by Raspberry Pi Ltd. The design aligns with a multichannel instrument for ratiometric measurements, which has been demonstrated both in vivo and in vitro function ability (12). This system, while primary skin-attached, shares fundamental principles with the stand-off reader, including phosphorescence-based oxygen sensing and precision signal processing. Additionally, miniaturized cylindrical phosphorescent readers with a 25.4 mm diameter have been developed for bio-analyte monitoring (13). While these prior designs rely on skin contact, the stand-off reader extends these capabilities by allowing remote non-contact measurement, crucial for livestock applications where minimizing stress and handling is essential.

### Example 2

### Injectable Oxygen Sensing Hydrogel

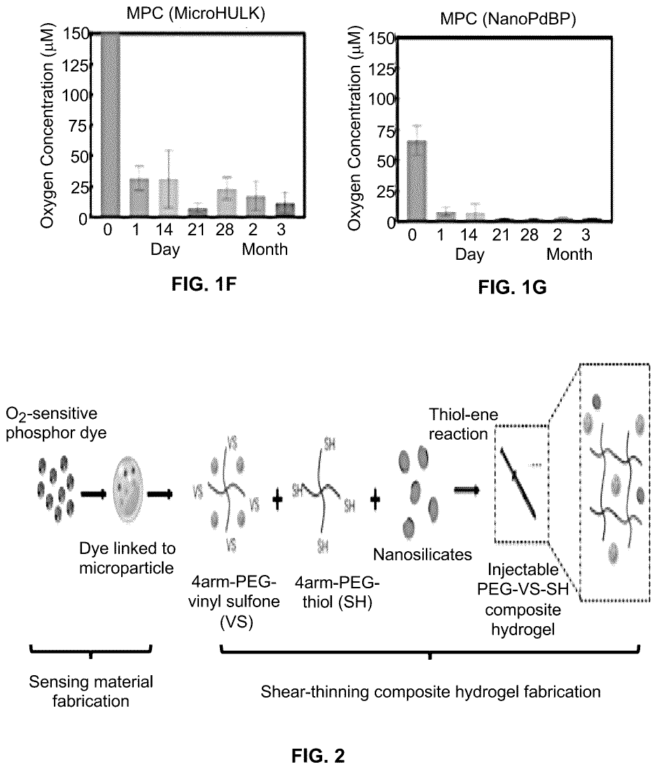

An injectable oxygen-sensing hydrogel platform is based on a metalloporphyrin dye, Pt(II) meso-Tetra (4-fluorophenyl)-tetrabenzoporphyrin that emits at 760 nm, compatible with the Fraunhofer line, thus ensuring minimal interference from ambient sunlight. The dye is electrostatically bound to biocompatible sulfate latex microparticles coated with polyallylamine hydrochloride. The stability is ensured through coating polyelectrolyte nanofilms for the stabilization of dyes and for controlling the diffusion of analytes. The functionalized microparticles are incorporated into a shear-thinning hydrogel matrix from PEG-vinyl sulfone and PEG-thiol in Laponite XLG that self-cross-links at physiological pH (FIG. 2).

Platinum-based porphyrin dyes typically have lifetimes ranging from 20 μs (under ambient oxygen) to 50-60 μs (under anoxic conditions). This results in a testable total range of only 30-40 μs, and at lower oxygen levels, the range narrows further, making it harder to detect small changes in tissue oxygenation. Alternatively, palladium-based benzoporphyrin dyes have broader lifetime ranges and is suitable especially if limited lifetime ranges under low tissue oxygen conditions are encountered. Additionally, achieving effective dispersion of the oxygen-sensing microparticles within the hydrogel matrix and obtaining the desired shear-thinning properties requires careful fine-tuning of the pH in the hydrogel precursor solutions. The hydrogel requires a wait time of approximately 10-15 minutes to fully crosslink under physiological pH. This crosslinking time may be adjusted by modifying the pH of the polymeric solution (basic pH accelerates crosslinking within minutes, while lower pH increases gelation time). This adjustment ensures sufficient time for the hydrogel to self-crosslink, facilitating proper handling and injection at the intended site.

### Microparticles Synthesis

Stable and efficient oxygen-sensing microparticles are designed and fabricated. Sulfate latex microparticles (10 microns) are selected for their compatibility and scalability in manufacturing. These are coated with polyallylamine hydrochloride, providing a positively charged surface for binding the oxygen-sensitive Dye, Pt(II) meso-Tetra(4 fluorophenyl) tetrabenzoporphyrin (Frontier Chemicals). The hydrophobic core encapsulates the non-polar dye, preventing dissolution in aqueous environments and maintaining sensing functionality. Polyelectrolyte nanofilm coatings are added to the microparticles to further stabilize the electrostatically linked dye, thereby addressing potential sensor-to-sensor response variations. Sensing microparticles batches are characterized for oxygen sensitivity by dispersing them in hydrogel formulations and testing their responses against varying dissolved oxygen concentrations. Sensors are tested at 2 weeks and 4 weeks of time duration stored under physiological conditions (buffer and temperature). Additional characterization is performed via absorption spectra collection through UV-vis spectrophotometer and concentration determination via a dried weight method.

### Shear-Thinning Hydrogel Matrix Synthesis

The shear-thinning hydrogel matrix to house the oxygen-sensing microparticles is formulated. Precursor solutions of PEG-vinyl sulfone in Laponite XLG are prepared and are mixed with 50 mg/mL of sensing microparticles. Separately, PEG thiol in Laponite XLG is prepared. Pre-crosslinked gels are characterized using rheological tests to determine and validate shear-thinning properties, as well as to measure G′ (storage modulus) and G″ (loss modulus). Upon mixing, the two solutions undergo self-crosslinking at physiological PH to form an injectable hydrogel matrix. Post-crosslinking, compression tests are performed to determine the elastic moduli of the crosslinked gel. The shear-thinning properties provide easy injectability through a syringe with minimal trauma to tissues and thus support use in minimally invasive applications. The stable matrix ensures longevity in function toward oxygen sensing in biological environments.

### Validation of Oxygen-Sensing Hydrogel Performance

For oxygen sensitivity response studies, four 4 mm diameter, 0.75 mm high hydrogel sensor discs will be mounted in a flow cell. Dissolved oxygen concentrations (0-258 μM or 0% to 21% ambient levels) are controlled using MKS mass flow controllers, bubbling air/nitrogen mixtures into a TRIS buffer circulated over the samples at 37° C. Phosphorescence lifetimes (630 nm excitation, 760-800 nm emission) will be recorded every 10 seconds as oxygen concentrations vary. Sensor sensitivity and stability are assessed using the Stern-Volmer (SV) relationship to ensure accuracy and reproducibility.

Success is determined by the successful operation and consistent measurement of lifetime outputs (R²≥0.98 from SV plots) at various oxygen concentrations (0% to 21% ambient levels). In vitro testing conditions over a 4-week period are used to evaluate the stability of sensing performance of the oxygen-sensing material.

### Example 3

### Biosensor Reproducibility: Methodology

### Batch Fabrication

A reliable testing procedure to assess and reduce batch-to-batch sensor variability in terms of sensor performance. This ensures a consistent manufacturing process for injectable oxygen-sensing hydrogels with optimal sensor performance. Reliability testing is performed under in vitro conditions of increasing complexity, focusing on batch-to-batch variability. These tests evaluate microparticle stability and hydrogel characteristics, guaranteeing that manufacturing quality standards are met and ensuring functional stability and performance for scalable manufacturing applications.

Several batches of oxygen-sensing microparticles (N=20-25) are manufactured and are embedded into the shear-thinning hydrogel formulation. Each undergoes baseline testing in controlled in vitro conditions. The hydrogel sensors manufactured are exposed to different concentrations of oxygen, such as 0%, 2%, 10%, and 21% O₂, to measure the lifetimes of phosphorescence and establish initial oxygen sensitivity. The measurements are carried out three times: on Day 0, Day 14, and Day 28. These tests establish the functionality and stability baseline in order to understand the batch-to-batch variability in controlled environments.

### Testing in an Ex Vivo Environment

Ex-vivo conditions are tested on cow ear tissues (Meat and Science Department at Texas A&M University) using a test bed setup. Sensors are tested under similar oxygen concentration ranges, but the emphasis shifts to replicating physiological temperature and light conditions. These tests validate the material's stability, performance consistency, and functionality across batches, ensuring readiness for field deployment in livestock health monitoring.

The reliability of batch-to-batch test results, defined by SV plots with R²≥0.98 and lifetime outputs at lower oxygen concentrations under 90% confidence interval with ±10-15% margin of error from tested batches determine the success in 0% to 3% oxygen levels over a 4-week period under in vitro test conditions. For the ex vivo tests SNR>10 is expected.

### Example 4

### Stand-Off Optical Reader: Methodology

### Ambient Light Rejection

Interference from ambient light is reduced. The optical filter in the ambient light shield is utilized for an ultra-narrow bandwidth of 10 nm centered at 760 nm on the sensor's emission wavelength around. The narrow passband filter enables only the relevant phosphorescent emission light to pass through while blocking other wavelengths of sunlight. Additionally, the field of view of the photodetector is restricted using the ambient light shield, and recessing the photodetector, to focus solely on the region containing the implanted sensor, further reducing stray light contamination.

Alternatively, a 1 nm filter (760.7-1 OD4 Ultra Narrow Bandpass) centered more precisely at the Fraunhofer line at 760 nm. Similar to all electronic circuits with a feedback path, there exists the potential for instability. As such, the circuit needs to be examined to ensure its stability. To do so, the Laplace domain representation of the circuits proposed is extracted and modelled as a standard feedback system.

### Ambient Light Cancelation Circuit

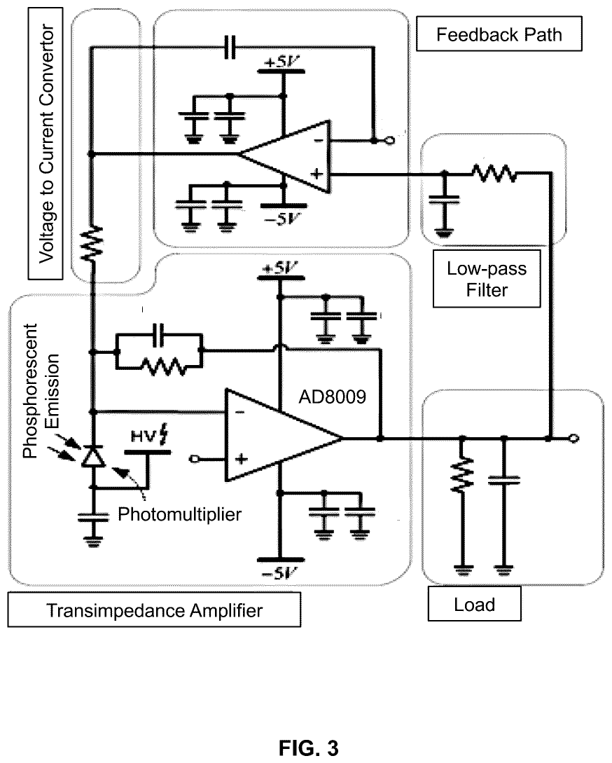

An electrical subsystem for the cancellation of residual ambient light effects is designed and integrated (FIG. 3). A cancellation circuitry detects the DC shift that the ambient light would have caused at the output of the photodetector array and inject an equal but opposite DC current. This offsets the contribution of the ambient light to the system, hence allowing the transimpedance amplifier (TIA) to process only the emission signal that originates from the implanted sensor. The output voltage at the output is sensed and passed through a low-pass filter to extract its DC shift value. The feedback opAmp equalizes the voltages on its two paths effectively cancelling the DC shift on the output signal.

The feed-forward (A) and fee-back (f) gains are calculated in the Laplace domain and Nyquist stability analysis is carried out. The circuit component values are chosen to ensure a positive gain margin and phase margin of at least 45 degrees. An AC coupling capacitor on the input of the transimpedance amplifier may be used to reject all DC current to improve stability.

### Validation in Real-World Conditions

The stand-off optical reader is tested in simulated field conditions with incident sunlight intensities of up to 10,000 lux. The optical and electrical systems are refined to detect precisely and reliably oxygen-sensitive phosphorescent signals from a distance of up to 3 cm distance. Other adjustments include the adoption of an RFID reader used in ordinary, radiofrequency tagging techniques common to cattle management regarding the mechanical design to easily interface within farm usage, with high-level output stability under adverse weather conditions, for example, blizzard, rain, etc., commonly encountered outside for the rapid execution of such disease-tracing functions.

The standoff reading instrument is evaluated in ambient sunlight achieving the following performance: (i) ~99% sunlight interference signal cancellation, measured by optical power meters, (ii) a controlled/known 1 nW of optical signal, emitted from the implantable sensor, detectable with the reader and (iii) data is successfully transferred to the cloud and successfully retained on demand.

### Creation of a Cloud Based Storage and Analysis Server

The data collected by the stand-off optical reader is transferred to an elastic AWS (Amazon Web Services) based server configured so the data is identifiable for each animal and analysis is performed therein.

### REFERENCES

1. Guterbock, W. M. Anim. Heal. Res. Rev., 15:130-134 (2014).
2. Borisov, et al., J. Photochem. Photobiol. A Chem. 201:128-135 (2009).
3. Zirath, et al., Front. Physiol. 9:1-12 (2018).
4. Najdahmadi, et al., MRS Adv. 5:991-1000 (2020).
5. Pradhan, et al. ACS Sensors 9, 6060-6070 (2024).
6. Williams, et al. J. Mater. Chem. B 11, 1749-1759 (2023).
7. Chimene, et al. ACS Appl. Bio Mater. 7, 3964-3980 (2024).
8. Rebelo, et al., Engineering 7:1696-1699 (2021).
9. Bornhoeft, et al., Biosensors 7, (2017).
10. Biswas, et al., ACS Sensors 2:1584-1588 (2017).
11. Soundaram Jeevarathinam, et al., Biosensors 13, (2023).
12. Zavareh, et al., IEEE Access 9:103835-103849 (2021).
13. Zavareh, et al., In 2022 IEEE Healthcare Innovations and Point of Care Technologies (HI-POCT) 81-84 (2022).
14. de Oliveira, et al., Curr. Med. Chem. 27:3519-3533 (2020).
15. Deiss, et al., Diabetes Technol. Ther. 21, 254-264 (2019).
16. Youssef, et al. Today Bio 22:100764 (2023).
17. Fulton, R. W. Anim. Heal. Res. Rev. 10, 131-139 (2009).
18. Ahmed, et al., J. Med. Surgery, Public Heal. 2:100081 (2024).
19. Estimates of Foodborne Illness in the United States.
20. Preview: Economic Effects of Bovine Respiratory Disease. J. Anim. Sci. 98:skaa042 (2020).
21. Overton, M. W., Anim. Heal. Res. Rev. 21:143-148 (2020).
22. Health and Management Practices on U.S. Dairy Operations, 2014.
23. Buczinski, et al., J. Dairy Sci. 104:8214-8227 (2021).
24. van der Fels-Klerx, et al., Prev. Vet. Med. 51, 75-94 (2001).
25. Antibiotic Use and Stewardship in the United States, 2024 Update: Progress and Opportunities.
26. Veterinary Feed Directive (VFD). fda.gov/animal-veterinary/development-approval-process/veterinary-feed-directive-vfd.
27. National Animal Health Monitoring System. aphis.usda.gov/livestock-poultry-disease/nahms.
28. BFortune Business Insights, fortunebusinessinsights.com/industry-reports/bio-sensors-market-100146.
29. Statista. https://www.statista.com/statistics/263979/global-cattle-population-since-1990/#: ~:text=How many cattle are in, approximately 1.51 million in 2021.
30. How Many Dairy Cows Are There? pangovet.com/statistics/cattle/how-many-dairy-cows-are-there-statistics/#:~:text=There are roughly 270 million, pounds of milk in 2021.
31. Statista. statista.com/statistics/194297/total-number-of-cattle-and-calves-in-the-us-since-2001/#:~:text=How many cows are in, slightly from the 2023 value.
32. RFID Tags for Agricultural Application Market Report 2025 (Global Edition). cognitivemarketresearch.com/rfid-tags-for-agricultural-application-market-report? srsltid=AfmBOoqzZcvS41PDfKx-UYkTsY4FacUbsXle1Zl_as4IFUU5t54T5kU.
33. USDA Economic Research Service. ers.usda.gov/data-products/chart-gallery/gallery/chart-detail?chartId=58268.

What is claimed is:

1. An optical biosensor, comprising:
a fluorinated metalloporphyrin dye complex; and
a plurality of functionalized particles coated with layers of a polyelectrolyte nanofilm electrostatically encapsulating the fluoreinated metalloporphyrin dye complex.

2. The optical biosensor of claim 1, further comprising a functionalizing enzyme encapsulated with the fluorinated metalloporphyrin dye complex.

3. The optical biosensor of claim 1, wherein the fluorinated metalloporphyrin dye complex is a Pt(II) meso-Tetra (4-fluorphenyl)-tetrabenzoporphyrin dye complex or a Pd(II) meso-Tetra (4-fuorphenyl)-tetrabenzoporphyrin dye complex.

4. The optical biosensor of claim 1, wherein the fluorinated metalloporphyrin dye complex emits phosphorescent light at a solar Fraunhofer line.

5. The optical biosensor of claim 1, wherein the functionalized particles are functionalized microparticles or functionalized nanoparticles.

6. The optical biosensor of claim 5, wherein the plurality of functionalized microparticles or functionalized nanoparticles each comprise sulfate latex coated with polyallylamine hydrochloride.

7. An injectable hydrogel sensing platform, comprising:
the optical biosensor of claim 1; and
a shear-thinning hydrogel matrix encapsulating the optical biosensor, said shear-thinning hydrogel matrix formulated from two polyethylene glycol functionalized polymers crosslinkable upon injection into a tissue.

8. The injectable hydrogel sensing platform of claim 7, wherein the two polyethylene glycol functionalized polymers comprises polyethylene glycol-vinyl sulfone and polyethylene glycol-thiol.

9. A system to measure a biomarker associated with a pathology in livestock, comprising:
the injectable hydrogel sensing platform of claim 7;
a stand-off reading instrument configured to both optically excite the optical biosensor and read phosphorescent light signals emitted therefrom at a distance in the presence of the iomarker, said stand-off reading instrument in electronic communication with a cloud-based platform; and
a database configured for correlation of the emitted phosphorescent light signals with the pathology.

10. The system of claim 9, wherein the stand-off reading instrument is configured for a distance of at least 1.0 cm.

11. The system of claim 9, wherein the optical biosensor has an emission wavelength at a solar Fraunhofer line.

12. The system of claim 11, wherein the wavelength is about 760 nm.

13. A method for detecting a pathology in livestock, comprising:
injecting the injectable hydrogel sensing platform comprising the system of claim 9 into at least one of the livestock, said two polyethylene glycol polymers crosslinking upon injection thereby encapsulating the optical biosensor;
exciting, via the stand-off reading instrument, the optical biosensor with a Fraunhofer wavelength selected to produce phosphorescent light signals emitted from the optical biosensor in the presence of a biomarker associated with the pathology;
receiving, in the stand-off reading instrument, the phosphorescent light signals, and
transmitting the phosphorescent light signals to a cloud-based platform as data for analysis as correlative with the pathology.

14. The method of claim 13, further comprising storing the data in the cloud-based platform.

15. The method of claim 13, further comprising monitoring the livestock for the presence or an absence of the biomarker as indicative of a presence or an absence of the pathology.

16. The method of claim 15, wherein data collected during the monitoring step comprises input with previously collected data for a machine learning algorithm configured to analyze the input to generate information predictive of the pathology in the livestock.

17. The method of claim 13, wherein analysis of the data comprises comparing the emitted phosphorescent light signals to a database.

18. The method of claim 13, wherein the biomarker is oxygen, temperature, glucose, beta-hydroxybutyrate, lactate, pH, or calcium.

19. The method of claim 13, wherein the pathology is scours, bovine, respiratory disease, mastitis, hypocalcemia, displaced abomasal disorder, or ketosis.

20. The method of claim 13, wherein the livestock are dairy cows, beef cattle or other feed animals.
